(19) United States
(12) Patent Application Publication
(10) Pub. No.: US 2004/0262302 A1
(43) Pub. Date: Dec. 30, 2004

(54) Magnetron with evaporation baffle

(76) Inventor: Jonathan D. Barry, Frederick, MD (US)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/606,242

(22) Filed: Jun. 26, 2003

(51) Int. Cl. H05B 6/74

(52) U.S. Cl. 219/746

(57) ABSTRACT

The invention is a magnetron 10 and a method of operation of a magnetron. A magnetron in accordance with the invention comprises an anode cylinder (14); a cathode (12) disposed within the anode cylinder; a plurality of vanes (16) extending inward into the anode cylinder so as which form a plurality of resonant cavities; an electrically insulative magnetron chamber wall (20) coupled to the anode; an antenna (18) coupled to at least one of the vanes which provides an output of microwaves passing through the electrically insulative magnetron chamber wall when the magnetron is operating; and at least one baffle (102, 202 and 302) disposed in lines of sight (40, 42, 44 and 46) between the cathode and the electrically insulative magnetron chamber wall on which material emitted from the cathode is deposited instead of on the electrically insulative magnetron chamber wall.

### BACKGROUND OF THE INVENTION

1. Field of the Invention

The present invention relates to magnetrons and to methods of operating magnetrons having an extended service life.

2. Description of the Prior Art

FIG. 1 illustrates a prior art magnetron 10 of conventional construction in which the present invention may be practiced, but it should be understood that the present invention is not limited thereto. The magnetron 10 includes a cathode 12 and a cylindrical metallic anode 14 disposed axially relative to the cathode. A plurality of vanes 16, which are circumferentially spaced around the inner periphery of the anode cylinder 14, project radially inward toward the cathode 12. The plurality of vanes 14 form a plurality of resonant cavities. An antenna 18 is joined to one of the vanes 16 which provides an output of microwaves passing through ceramic dome 20 which is part of the magnetron chamber wall defining an evacuated chamber 26. The ceramic dome 20 is joined by brazing to a metallic cylindrical section 21 which is preferably kovar. The metallic cylindrical section 21 is joined to the top pole piece 22 which is joined to the top of the cylindrical anode 14. An aperture 24, in the top annular magnetic pole piece 22, permits the antenna 18 to project from connection to one of the radially inwardly extending vanes 16 upward. Chamber 26 is formed by joining the metallic cylindrical section 21 to the ceramic dome 20. Similarly, a lower annular magnetic pole piece 28 is joined to the bottom of the cylindrical anode 14. The pole pieces 22 and 28 concentrate magnetic lines of flux provided by external magnets which are well-known and are not illustrated.

Operation of the magnetron 10 of FIG. 1 to produce an output of microwaves through the ceramic dome 20 is well known. The annular pole pieces 22 and 28 focus a magnetic field axially along magnetron axis 30 which is the axis of the cathode 12. During operation, electrons are emitted from the cathode which interact with the magnetic field and the plurality of resonant cavities so as to generate microwaves which are outputted by the antenna 18 through the ceramic dome 20.

The prior art of FIG. 1 has a plurality of lines of sight between the cathode 12 and an inner surface 38 of the ceramic dome 20. The many lines of sight are exemplified by arrows 40, 42, 44 and 46. During the long life of magnetron 10, it has been discovered that metallic material evaporates from the cathode 12 which deposits along the lines of sight from the cathode onto inner peripheral surface 38 and the top 39 of the ceramic dome 20. Over time, this metallic material builds up and substantially degrades the coupling between the magnetron 10 and a waveguide coupled thereto (not illustrated) to a magnetron powered application (not illustrated) such as an electrodeless lamp manufactured by the assignee of the present invention. As the coupling with the magnetron powered application decreases as a consequence of the metallic buildup on surface 38, the amount of power dissipated in the anode 18 increases, causing a temperature rise which accelerates failure of the magnetron 10.

The description of the prior art in FIG. 1 is representative of numerous magnetron designs having non electrically conductive magnetron chamber walls through which microwaves pass from an antenna to waveguides coupled to the magnetron. These magnetrons suffer from the aforementioned disadvantage of the prior art described with respect to FIG. 1 in which metallic material from the cathode deposits on the non-electrically conductive chamber wall through which microwaves pass, such as surface 38, causing the aforementioned degrading of the coupling resulting ultimately in premature failure unless the build up of metallic material on the inner surface can be prevented.

Chokes are well known in magnetrons which suppress the output of undesired harmonics such as the 5th harmonic. A choke functions as a coaxial transmission line segment which is substantially equal in length to ¼ of the electrical wavelength of the undesired harmonic to be suppressed.

### SUMMARY OF THE INVENTION

The present invention is a magnetron and a method of operating a magnetron which has improved service life. The invention prevents the prior art deposition of metallic material from the cathode onto an inner surface of non electrically conductive magnetron chamber walls of the magnetron through which the microwaves pass. In accordance with the invention, at least one baffle is disposed between the cathode and the inner surface of non electrically conductive magnetron chamber walls through which the microwaves pass in the lines of sight from the cathode within the evacuated chamber to the inner surface of the non electrically conductive magnetron chamber walls. The at least one baffle prevents the deposit of the metallic material on the chamber walls which in the prior art has led to premature failure of the magnetron. The at least one baffle may be mounted on an upper pole piece of the magnetron or on the antenna of the magnetron, such that the lines of sight from the cathode to the non electrically conductive magnetron chamber wall are occluded to the greatest practical extent. The at least one baffle may be a planar plate, which when mounted on the antenna, does not alone act as a choke to suppress undesired frequencies such as the 5th harmonic. A choke, for suppressing at least one undesired harmonic of the fundamental frequency of microwaves produced by the magnetron, may be integrally formed with the baffle. The choke comprises a closed wall which extends coaxially with the antenna joined to the planar plate of the at least one baffle with a length substantially equal to ¼ the wavelength of an undesired harmonic to be suppressed such as the 5th harmonic.

A magnetron in accordance with the invention includes an anode cylinder; a cathode disposed within the anode cylinder; a plurality of vanes extending radially inward from the anode cylinder so as to form a plurality of resonant cavities; an electrically insulative magnetron chamber wall coupled to the anode; an antenna, coupled to at least one of the vanes, located within the evacuated chamber of the magnetron which provides an output of microwaves passing through the electrically insulative chamber; and wherein the at least one baffle is disposed in lines of sight between the cathode and the insulative chamber wall including substantially all of a periphery and top of the electrically insulative magnetron chamber wall through which the microwaves pass with metallic material emitted from the cathode being deposited on the at least one baffle instead of on the electrically insulative magnetron chamber wall. The at least one baffle may comprise at least one planar plate which may be substantially orthogonal to a longitudinal axis of the magnetron. A pair of annular magnetic pole pieces may be connected to the anode which focus an externally provided magnetic field along the axis of the cathode and the at least one baffle may be connected to one of the pole pieces. The baffle may be connected to the antenna. A conductive closed wall may have a longitudinal axis coaxial with the longitudinal axis of an antenna segment and may be joined to the planar plate of the at least one baffle so that the closed wall, the planar plate and a segment of the antenna suppress at least one undesired harmonic of a fundamental frequency. The closed wall and the segment of the antenna may suppress a 5th harmonic of the fundamental frequency. The closed conductive wall may be substantially equal in length to one quarter of a wavelength of the undesired harmonic located within the evacuated chamber of the magnetron. The chamber wall may be a ceramic dome.

A method of operation of a magnetron including an anode cylinder, a cathode disposed within the anode cylinder, a plurality of vanes extending radially inward from the anode cylinder which form a plurality of resonant cavities, an electrically insulative magnetron chamber wall coupled to the anode and an antenna connected to at least one of the vanes which provides an output of microwaves passing through the electrically insulative magnetron chamber wall when the magnetron is operating providing at least one baffle disposed in lines of sight between the cathode and the electrically insulative chamber wall including substantially all of a periphery and top of the electrically insulative magnetron chamber wall through which the microwaves pass; activating the magnetron to produce an output of microwaves through the electrically insulative chamber wall with metallic material being emitted from the cathode during the output of microwaves being deposited on the at least one baffle instead of on the electrically insulative chamber wall. The at least one baffle may be at least one planar plate which may be substantially orthogonal to a longitudinal axis of the magnetron. A pair of annular magnetic pole pieces may be connected to the anode which focus an externally provided magnetic field axially along the cathode and the at least one baffle may be connected to one of the pole pieces. The baffle may be connected to the antenna. A conductive closed wall may have a longitudinal axis coaxial with the longitudinal axis and may be joined to the planar plate of the at least one baffle so that the closed wall and a segment of the antenna suppress at least one undesired harmonic of a fundamental of microwave resonance by the plurality of resonant cavities. The closed wall and the segment of the antenna may suppress a 5th harmonic of the fundamental frequency. The length of the closed conductive wall may be substantially equal to one quarter of the wavelength of the undesired harmonic located within an evacuated chamber of the magnetron. The chamber wall may be a ceramic dome.

### BRIEF DESCRIPTION OF THE DRAWINGS

FIG. 1 illustrates a prior art magnetron which is subject to the problem solved by the present invention.

FIG. 2 illustrates a first embodiment of the magnetron in accordance with the present invention.

FIG. 3 illustrates a second embodiment of the magnetron in accordance with the present invention.

FIG. 4 illustrates a third embodiment of the magnetron in accordance with the present invention.

Like reference numerals identify like parts throughout the drawings.

### DESCRIPTION OF THE PREFERRED EMBODIMENTS

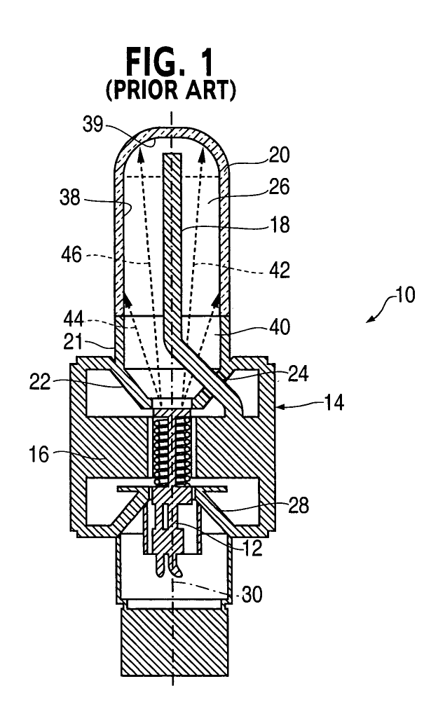

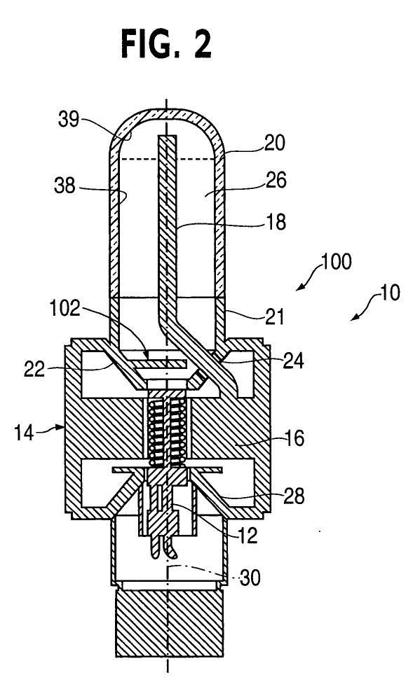

FIG. 2 illustrates a first embodiment 100 of the present invention. The first embodiment 100 functions in accordance with the operation of the prior art magnetron, such as exemplified by FIG. 1, providing an output of microwaves from the antenna 18 through an electrically insulative chamber wall 20 which as illustrated is a ceramic dome. At least one baffle 102 (only one baffle is illustrated) is connected to the upper pole piece 22 so as to occlude the lines of sight of metal deposition 40, 42, 44 and 46 of the prior art of FIG. 1 to the greatest practical extent. The point of connection of the at least one baffle 102 is not limited to a singe axial position along the longitudinal axis 30. The deposit of metal evaporating from the cathode 12 on the at least one baffle 102 will extend the life of the magnetron by preventing the prior art coating of the inner peripheral surface 38 and the top 39 of the electrically insulative chamber wall. The at least one baffle 102, may without limitation, be one or more planar metallic plates which may be steel, extend substantially orthogonal to the longitudinal axis 30 of the magnetron and are as thin as practical for fabrication and mounting such as a thickness of one sixteenth of an inch. While only a single baffle 102 is illustrated, it should be understood that multiple baffles, such as but not limited to planar plate sections, may be attached to different points on the pole piece 22. Other structures other than planar plates may be used to occlude the lines of sight 40, 42, 44 and 46 of the prior art of FIG. 1 to provide surfaces for cathode material deposition.

Viewed from the cathode 12, the at least one baffle 102 is designed and positioned to substantially occlude to the greatest practical extent all possible the lines of sight around the circular periphery of the insulative magnetron chamber wall 38. The top 39 is also substantially occluded to the greatest practical extent.

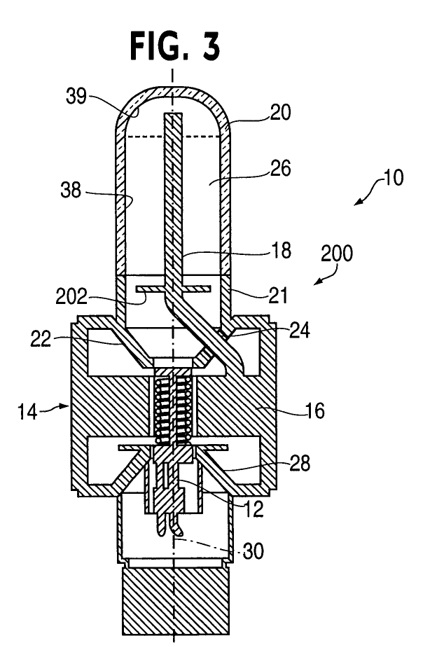

FIG. 3 illustrates a second embodiment 200 of the present invention, which operates in a manner similar to the first embodiment 100 of FIG. 2, except that the at least one baffle 202 is connected to the antenna 18. The at least one baffle may without limitation be planar plates attached to the antenna 18 at different axial positions of the longitudinal axis with a thickness similar to the first embodiment. The at least one baffle 202 occludes the lines of sight 40, 42, 44 and 46 of the prior art of FIG. 1 around the circular periphery of the magnetron chamber wall 38 and the top 39 to the greatest practical extent. The at least one baffle 202 may be at least one planar plate.

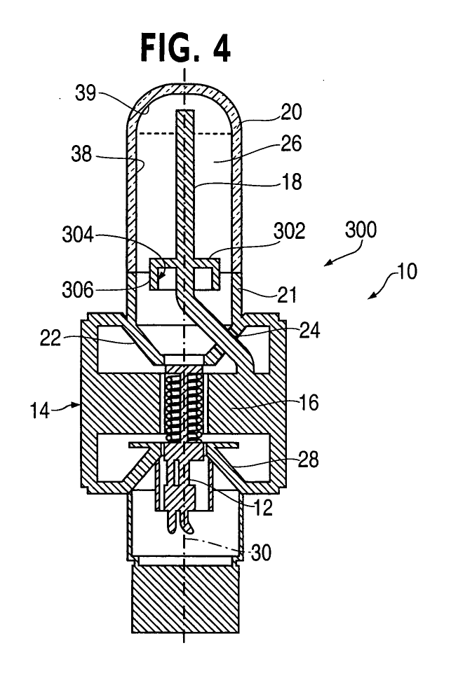

FIG. 4 illustrates a third embodiment 300 of the present invention having at least one baffle 302 which operates in a manner similar to the first embodiment 100 of FIG. 2 and the second embodiment 200 of FIG. 3, except that a choke 304 is joined to the planar surface of the at least one baffle 302 connected to the antenna 18. The at least one baffle 302 may without limitation be planar plates attached to antenna 18 at different axial positions. The choke 304 is comprised of a closed electrically conductive wall section 306 and a portion of the antenna 18 which is coaxial with the closed wall section. The choke 304 functions as a section of coaxial transmission line having an electrical length along the longitudinal axis 30 of the magnetron 10 and the radiating section of the antenna 18 which is substantially equal in length to ¼ of the wavelength of an undesired harmonic to be suppressed which for example may be a 5th harmonic of the fundamental frequency. The at least one baffle 302 has a thickness similar to the thickness of the first and second embodiments. The choke 304 is connected to the outside periphery of the at least one baffle 302. The closed wall 306 is preferably a cylindrical segment. Again, like the embodiments of FIGS. 2 and 3, the lines of sight 40, 42, 44 and 46 of the prior art of FIG. 1 around the circular periphery of the magnetron chamber wall 38 and the surface 39 are occluded to a greatest practical extent by the at least one baffle 302.

Thus in accordance with the embodiments of the invention as illustrated in FIGS. 2, 3 and 4, during the long life of the magnetron 10, during which the cathode 12 operates at high temperatures, the evaporation of metallic material from the cathode, while occurring, does not deposit metal around the periphery of the magnetron chamber wall 38 and the top 39 of the electrically insulative chamber wall 20 which is part of the evacuated chamber 26 of the magnetron 10 through which the microwaves are emitted after radiating from the antenna 18. The at least one baffle is metallic, operates at the potential of the anode 16, and functions as a deposition surface for the metallic evaporated cathode material.

While the invention has been described in terms of its preferred embodiments, it should be understood that numerous modifications may be made thereto without departing from the spirit and scope of the present invention. For example, the present invention is not limited to the magnetron structure as described in the prior art of FIG. 1. It is intended that all such modifications fall within the scope of the appended claims.

What is claimed is:

1. A magnetron comprising:
an anode cylinder;
a cathode disposed within the anode cylinder;
a plurality of vanes extending inward from the anode cylinder so as to form a plurality of resonant cavities;
an electrically insulative magnetron chamber wall coupled to the anode;
an antenna, coupled to at least one of the vanes, located within an evacuated chamber of the magnetron which provides an output of microwaves passing through the electrically insulative magnetron chamber wall when the magnetron is operating; and
at least one baffle disposed in lines of sight between the cathode and the electrically insulative magnetron chamber wall including substantially all of a periphery and a top of the electrically insulative magnetron chamber wall through which the microwaves pass with metallic material emitted from the cathode being deposited on the at least one baffle instead of on the electrically insulative magnetron chamber wall with the at least one baffle comprising at least one planar plate which is substantially orthogonal to a longitudinal axis of the magnetron.

2. A magnetron in accordance with claim 1 comprising:
a pair of annular magnetic pole pieces which are connected to the anode which focus a magnetic field axially along the cathode, and
the at least one baffle is connected to one of the pole pieces.

3. A magnetron in accordance with claim 1 wherein:
the at least one baffle is connected to the antenna.

4. A magnetron in accordance with claim 3 comprising:
a closed conductive wall having a longitudinal axis coaxial with a longitudinal axis of the antenna which is joined to the planar plate of the at least one baffle, the closed wall and a segment of the antenna suppressing at least one undesired harmonic of a fundamental frequency of microwave resonance of the plurality of resonant cavities.

5. A magnetron in accordance with claim 4 wherein:
the closed wall and the segment of the antenna suppresses a 5^{th} harmonic of the fundamental frequency.

6. A magnetron in accordance with claim 1 wherein:
the electrically insulative magnetron chamber wall comprises a ceramic dome.

7. A magnetron in accordance with claim 2 wherein:
the electrically insulative magnetron chamber wall comprises a ceramic dome.

8. A magnetron in accordance with claim 3 wherein:
the electrically insulative magnetron chamber wall comprises a ceramic dome.

9. A magnetron in accordance with claim 4 wherein:
the electrically insulative magnetron chamber wall comprises a ceramic dome.

10. A magnetron in accordance with claim 5 wherein:
the electrically insulative magnetron chamber wall comprises a ceramic dome.

11. A magnetron in accordance with claim 8 comprising:
a closed conductive wall having a longitudinal axis coaxial with a longitudinal axis of the antenna which is joined to the planar plate of the at least one baffle, the closed wall and a segment of the antenna suppressing at least one undesired harmonic of a fundamental frequency of microwave resonance of the plurality of resonant cavities.

12. A magnetron in accordance with claim 11 wherein:
the closed wall and the segment of the antenna suppresses a 5^{th} harmonic of the fundamental frequency.

13. A magnetron in accordance with claim 4 wherein:
the closed conductive wall is substantially equal in length to one quarter of a wavelength of the undesired harmonic.

14. A magnetron in accordance with claim 8 wherein:
the closed conductive wall is substantially equal in length to one quarter of a wavelength of the undesired harmonic.

15. A magnetron in accordance with claim 12 wherein:
the closed conductive wall is substantially equal in length to one quarter of a wavelength of the undesired harmonic.

16. A method of operation of a magnetron including an anode cylinder, a cathode disposed within the anode cylinder, a plurality of vanes extending radially inside the anode which form a plurality of resonant cavities, an electrically insulative magnetron chamber wall coupled to the anode and an antenna coupled to at least one of the vanes located within an evacuated chamber of the magnetron which provides an output of microwaves passing through the electrically insulative magnetron chamber wall when the magnetron is operating comprising:
providing at least one baffle disposed in lines of sight between the cathode and the electrically insulative magnetron chamber wall including substantially all of a periphery and a top of the electrically insulative magnetron chamber wall through which the microwaves pass with the at least one baffle comprising at least one planar plate which is substantially orthogonal to a longitudinal axis of the magnetron; and
activating the magnetron to produce an output of microwaves through the electrically insulative magnetron chamber wall with material being emitted from the cathode during the output of microwaves being deposited on the at least one baffle instead of on the electrically insulative magnetron chamber wall.

17. A method in accordance with claim 16 wherein:
the magnetron comprises a pair of annular pole pieces which are connected to the anode which focus a magnetic field axially along the cathode; and
the at least one baffle is connected to one of the pole pieces.

18. A method in accordance with claim 16 wherein:
the at least one baffle is connected to the antenna.

19. A method in accordance with claim 18 comprising:
a closed conductive wall having a longitudinal axis coaxial with a longitudinal axis of the antenna which is joined to the planar plate of the at least one baffle, the closed wall and a segment of the antenna suppressing at least one undesired harmonic of a fundamental frequency of microwave resonance of the plurality of resonant cavities.

20. A method in accordance with claim 19 wherein:
the closed wall and the segment of the antenna suppress a 5^{th} harmonic of the fundamental frequency.

21. A method in accordance with claim 16 wherein:
the electrically insulative magnetron chamber wall comprises a ceramic dome.

22. A method in accordance with claim 17 wherein:
the electrically insulative magnetron chamber wall comprises a ceramic dome.

23. A method in accordance with claim 18 wherein:
the electrically insulative magnetron chamber wall comprises a ceramic dome.

24. A method in accordance with claim 19 wherein:
the electrically insulative magnetron chamber wall comprises a ceramic dome.

25. A method in accordance with claim 20 wherein:
the electrically insulative magnetron chamber wall comprises a ceramic dome.

26. A method in accordance with claim 19 wherein:
the closed conductive wall is substantially equal in length to one quarter of a wavelength of the undesired harmonic.

27. A method in accordance with claim 20 wherein:
the closed conductive wall is substantially equal in length to one quarter of a wavelength of the undesired harmonic.

28. A method in accordance with claim 24 wherein:
the closed conductive wall is substantially equal in length to one quarter of a wavelength of the undesired harmonic.

29. A magnetron comprising:
an anode cylinder;
a cathode disposed within the anode cylinder;
a plurality of vanes extending inward from the anode cylinder so as to form a plurality of resonant cavities;
an electrically insulative magnetron chamber wall coupled to the anode;
an antenna, coupled to at least one of the vanes, located within an evacuated chamber of the magnetron which provides an output of microwaves passing through the electrically insulative magnetron chamber wall when the magnetron is operating; and
at least one baffle disposed in lines of sight between the cathode and the electrically insulative magnetron chamber wall including substantially all of a periphery and a top of the electrically insulative magnetron chamber wall through which the microwaves pass with metallic material emitted from the cathode being deposited on the at least one baffle instead of on the electrically insulative magnetron chamber wall.

30. A method of operation of a magnetron including an anode cylinder, a cathode disposed within the anode cylinder, a plurality of vanes extending radially inside the anode which form a plurality of resonant cavities, an electrically insulative magnetron chamber wall coupled to the anode and an antenna coupled to at least one of the vanes located within an evacuated chamber of the magnetron which provides an output of microwaves passing through the electrically insulative magnetron chamber wall when the magnetron is operating comprising:
providing at least one baffle disposed in lines of sight between the cathode and the electrically insulative magnetron chamber wall including substantially all of a periphery and a top of the electrically insulative magnetron chamber wall through which the microwaves pass; and
activating the magnetron to produce an output of microwaves through the electrically insulative magnetron chamber wall with material being emitted from the cathode during the output of microwaves being deposited on the at least one baffle instead of on the electrically insulative magnetron chamber wall.
